(19) United States
(12) Patent Application Publication
(10) Pub. No.: US 2015/0125166 A1
(43) Pub. Date: May 7, 2015

(54) DEVELOPER CONTAINER, DEVELOPING APPARATUS, PROCESS CARTRIDGE AND IMAGE FORMING APPARATUS

(71) Applicant: CANON KABUSHIKI KAISHA, Tokyo (JP)

(72) Inventors: Akihisa Matsukawa, Fuchu-shi (JP); Toshiya Kaino, Suntou-gun (JP); Keisuke Mochizuki, Suntou-gun (JP); Bunro Noguchi, Suntou-gun (JP); Shun Sato, Ashigarakami-gun (JP); Masahiro Shibata, Numazu-shi (JP); Yoshihiro Mitsui, Numazu-shi (JP); Hisashi Yamauchi, Numazu-shi (JP)

(21) Appl. No.: 14/529,803

(22) Filed: Oct. 31, 2014

(30) Foreign Application Priority Data
Nov. 5, 2013 (JP) 2013-229714

(51) Int. Cl. G03G 15/08

(52) U.S. Cl. CPC G03G 15/0889
USPC 399/27

(57) ABSTRACT

Provided is a technology that enhances the detection precision of the residual amount of a developer. An apparatus according to the invention includes: an accommodating portion in which a developer is accommodated; a sheet-like stirring member that, by rotating, stirs the developer accommodated in the accommodating portion; a piezoelectric element that is affixed to the stirring member and that outputs voltage when being deformed; and a deflection forming portion that comes in contact with the stirring member, thereby causing the stirring member to deflect, when a free end of the rotating stirring member is outside a developer accumulation region in the accommodating portion.

### BACKGROUND OF THE INVENTION

1. Field of the Invention

The present invention relates to a developer container, a developing apparatus, a process cartridge and an image forming apparatus.

2. Description of the Related Art

Developing assemblies that are used in image forming apparatuses such as electrophotographic printers or the like comprise ordinarily a developer container in which a developer (toner) is accommodated, and a developing roller, rotatably provided at an opening of the developer container, and which carries and transports the developer from inside the developer container. The developer inside the developer container is stirred through rotation of a stirring member that is provided inside the developer container, is transported by the developing roller, and is consumed thereupon by being used to develop an electrostatic latent image.

Herein, Japanese Patent Application Publication No. H3-271785 discloses, as a method for detecting a residual amount of the consumed developer from inside the developer container, a method that involves detecting the pressure (toner powder pressure) that the developer exerts on the stirring member. In the method disclosed in Japanese Patent Application Publication No. H3-271785, the stirring member is provided with a piezoelectric element, such that the residual amount of the developer is detected on the basis of changes in the developer pressure exerted on the piezoelectric element.

### SUMMARY OF THE INVENTION

In the configuration of Japanese Patent Application Publication No. H3-271785, a plate-like polymer piezoelectric element is affixed to a paddle surface of a rigid stirring member. The polymer piezoelectric element detects, in the form of change of generated voltage, small changes in the pressure that the developer exerts on a piezoelectric surface, in the thickness direction. Changes in generated voltage arise as a result of deformation of the piezoelectric element. Herein, the deformation of the piezoelectric element derived from developer pressure in the thickness direction involves only deformation of contracting in the thickness direction. The resulting deformation amount is very small, and the changes in generated voltage are likewise extremely small. Accordingly, the sensitivity of the piezoelectric element, as a sensor, is very low, and detection precision is limited.

It is an object of the present invention to provide a technology that allows enhancing the detection precision of the residual amount of a developer.

To attain the above goal, a developer container of the present invention, comprising:

an accommodating portion in which a developer is accommodated;

a sheet-like stirring member that, by rotating, stirs the developer accommodated in the accommodating portion;

a piezoelectric element that is affixed to the stirring member and that outputs voltage, when being deformed; and

a deflection forming portion that comes in contact with the stirring member, thereby causing the stirring member to deflect, when a free end of the rotating stirring member is outside a developer accumulation region in the accommodating portion.

To attain the above goal, a developing apparatus of the present invention, comprising:

the developer container; and

a developer carrier, provided in an opening of the developer container, and carrying a developer.

To attain the above goal, a process cartridge of the present invention for performing an image forming process of forming an image, by way of a developer, on a recording medium, the process cartridge being configured so as to be detachably mounted to an apparatus main body of an image forming apparatus,

wherein the process cartridge comprises the developer container.

To attain the above goal, an image forming apparatus of the present invention in which an image is formed by a developer on a recording medium,

the apparatus comprising:

the developer container;

voltage detection means for detecting voltage that is outputted by the piezoelectric element; and

developer residual amount detection means for detecting a residual amount of the developer that is accommodated in the accommodating portion, on the basis of a voltage value detected by the voltage detection means, wherein

the developer residual amount detection means

detects the residual amount of the developer on the basis of

a reference voltage value, which is an output voltage value of the piezoelectric element detected by the voltage detection means upon occurrence of flexural deformation due to contact of the stirring member with the deflection forming portion, and

an effective value of an output voltage value of the piezoelectric element detected by the voltage detection means while the stirring member is passing through the accumulation region, from among output voltage values of the piezoelectric element outputted over one rotation of the stirring member.

The present invention succeeds thus in providing a technology that allows enhancing the detection precision of the residual amount of a developer.

Further features of the present invention will become apparent from the following description of exemplary embodiments with reference to the attached drawings.

### BRIEF DESCRIPTION OF THE DRAWINGS

FIG. 1 is a schematic diagram illustrating the configuration of a developer container according to Embodiment 1 of the present invention;

FIGS. 2A and 2B are schematic cross-sectional diagrams illustrating the configuration of a stirring member;

FIG. 3 is a schematic cross-sectional diagram of a process cartridge and an image forming apparatus;

FIGS. 4A and 4B are schematic diagrams illustrating the configuration of a stirring member in an embodiment of the present invention;

FIGS. 5A and 5B are a flowchart of toner residual amount detection;

FIGS. 6A to 6F are schematic cross-sectional diagrams of a developing apparatus, illustrating the progress of a stirring-circulation process;

FIG. 7 is a voltage waveform diagram of a piezoelectric element during rotation of a stirring member in a conventional example;

FIG. 8 is a voltage waveform diagram of a piezoelectric element during rotation of a stirring member in an embodiment of the present invention;

FIG. 9 is a diagram illustrating the profile of detection results of a toner residual amount in a conventional example;

FIG. 10 is a diagram illustrating the profile of detection results of toner residual amount in an embodiment of the present invention;

FIGS. 11A and 11B are schematic cross-sectional diagrams illustrating the configuration of a developing apparatus according to a variation of Embodiment 1 of the present invention; and

FIGS. 12A and 12B are schematic cross-sectional diagrams illustrating the configuration of a developing apparatus according to a variation of Embodiment 2 of the present invention.

### DESCRIPTION OF THE EMBODIMENTS

Now, with reference to the drawings, the implementation of the present invention will be described below in detail in an illustrative manner based on embodiments. However, the sizes, materials, shapes, relative arrangements, and the like of components described in the embodiments should be appropriately changed in accordance with the configuration of an apparatus to which the invention is applied or with any of various conditions. That is, the scope of the invention is not intended to be limited to the following embodiments.

### Embodiment 1

### Schematic Configuration Diagram of an Image Forming Apparatus

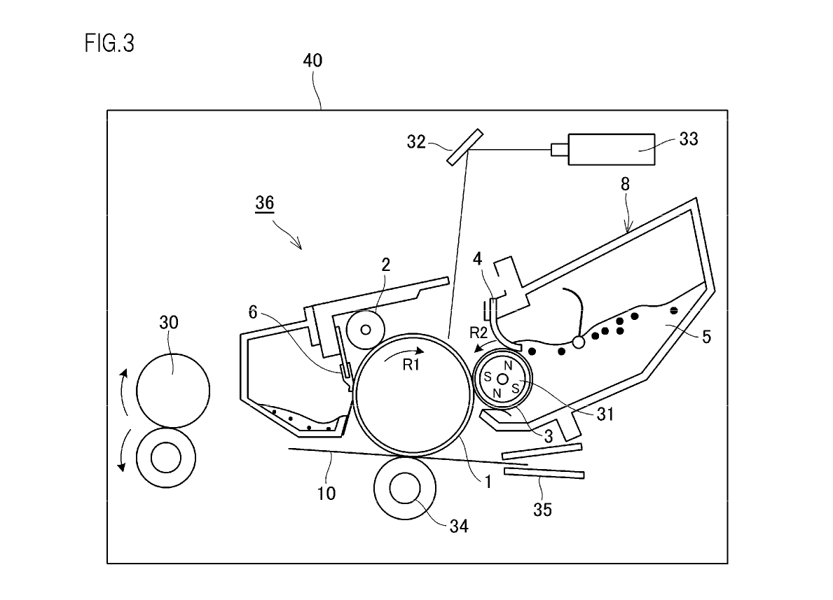

FIG. 3 is a schematic cross-sectional diagram illustrating the schematic configuration of a process cartridge and an image forming apparatus according to an embodiment of the present invention. An example of a laser beam printer of detachable process cartridge type will be explained in the present embodiment as the image forming apparatus.

Herein, the term image forming apparatus (electrophotographic image forming apparatus) denotes an image forming apparatus in which an image is formed on a recording material (recording medium), by a developer (toner), as a result of an electrophotographic image forming process. Examples of the image forming apparatus include, for instance, electrophotographic copiers, electrophotographic printers (LED printers, laser beam printers and the like), electrophotographic fax machines and electrophotographic word processors, as well as multifunction machines (multifunction printers) of the foregoing. The term recording material denotes a material on which an image is formed, for instance recording sheets, OHP sheets and the like.

The term process cartridge denotes a member resulting from integrating, in the form of a cartridge, an electrophotographic photoconductor drum and at least one from among a charging device, a developing means and a cleaning means, as a process means that acts on the electrophotographic photoconductor drum. This process cartridge is configured to be detachably mounted to the main body of the image forming apparatus. In the explanation below, the term image forming apparatus main body (hereafter “apparatus main body”) denotes an apparatus configuration portion that results from excluding at least the process cartridge, the developing apparatus or the developer container from the configuration of the apparatus main body.

In FIG. 3, the reference symbol 1 denotes an electrophotographic photoconductor of rotary drum type, being an organic photoconductor (OPC) wherein a photoconductor layer comprising an organic photoconductor layer is formed on the outer periphery of a grounded cylindrical aluminum substrate. The OPC photoconductor 1 is rotationally driven, at a predetermined process speed (peripheral speed) of for instance 200 mm/sec, in the clockwise direction R1 of the arrow. The reference symbol 2 denotes a charging roller, as a contact charging member that is brought in contact with the OPC photoconductor 1. In the case of the present embodiment, the charging roller 2 is rotationally driven accompanying the rotational driving of the OPC photoconductor 1.

In the rotation process thereof, the OPC photoconductor 1 (hereafter, photoconductor 1) undergoes a charging process of being homogeneously charged, to a predetermined polarity (negative, in the present embodiment) and predetermined potential, by the charging roller 2 to which an oscillating voltage (VAC+VDC) is applied. The charging process surface of the photoconductor 1 undergoes scanning exposure by an exposure device 33, via a mirror 32. A laser beam emitted by the exposure device 33 is modulated in accordance with a time-series electric digital image signal, of the intended image information, as outputted by a laser scanner not shown. An electrostatic latent image corresponding to the intended image information becomes formed as a result on the surface of the OPC photoconductor 1.

Toner negatively charged by a developing sleeve 3 of a developing apparatus 8 is supplied to the electrostatic latent image formed on the photoconductor 1, and the electrostatic latent image becomes reverse-developed thereby. A predetermined developing bias from a high-voltage power source (not shown) is applied to the sleeve 3.

Meanwhile, a recording material (transfer material) 10 is fed, from a paper feed unit, not shown, to a contact nip section (transfer section) of the photoconductor 1 and a transfer roller 34, by way of a transfer guide 35, in concert with the timing of the toner image on the photoconductor 1. The toner image is transferred from the surface of the photoconductor 1 onto the surface of the recording material 10. A predetermined transfer bias from the high-voltage power source is applied to the transfer roller 34; thereby, the toner image is transferred on account of the transfer bias. The recording material 10 having passed through the transfer section is introduced into a fixing apparatus 30. The toner image undergoes there a fixing process, and is outputted in the form of an image formed product.

After transfer of the toner image to the recording material 10, the developer remaining on the photoconductor 1 is removed and recovered by a cleaning device 6.

In the present embodiment, four process devices in the above configuration, namely the photoconductor 1, the charging roller 2, the developing apparatus 8 and the cleaning device 6 are configured integrally in the form of the process cartridge 36, so as to be detachably mounted to an apparatus main body 40 of the image forming apparatus. The cartridge configuration is not limited to the configuration disclosed herein, and it suffices that the cartridge be provided with at least one from among the photoconductor 1, the charging member 2, the developing apparatus 8 and the cleaning device 6.

The process cartridge 36 has a slit window hole through which a laser beam from the exposure device 33 is incident, and an opening and closing shutter unit (not shown) facing the exposed section on the underside of the photoconductor 1. These openings are configured so as to remain closed while the process cartridge 36 is removed from the apparatus main body 40, and to remain open while fitted to the apparatus main body 40. When the process cartridge 36 is fitted to the apparatus main body 40, the process cartridge 36 becomes mechanically and electrically coupled to a driving mechanism that is provided on the apparatus main body 40 side. As a result, this enables driving of, for instance, the photoconductor 1 or the developing sleeve 3 of the developing apparatus 8, and allows a predetermined bias to be applied to the charging roller 2, the developing sleeve 3 and the like, from a power source on the apparatus main body 40 side.

<Developing Apparatus>

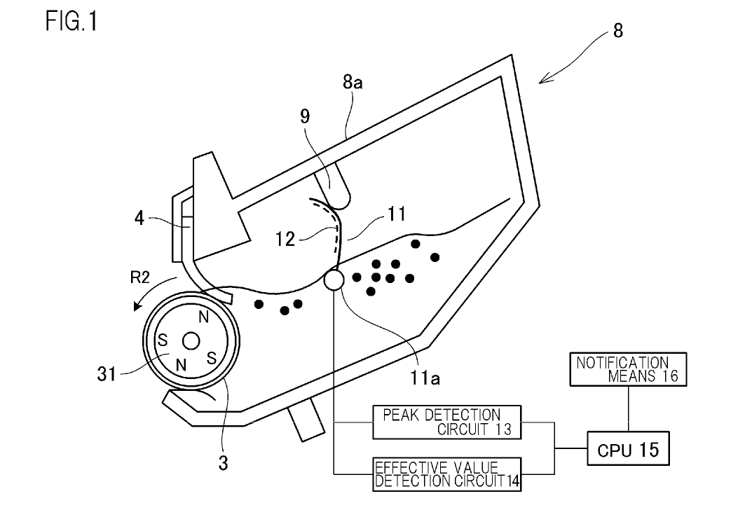

FIG. 1 is a schematic cross-sectional diagram illustrating the configuration of the developing apparatus according to the present embodiment. The developing apparatus 8 comprises a developer container 8a that accommodates toner (developer) 5, the developing sleeve 3 as a developing roller, an elastic blade 4 as a developer regulation member, and a stirring member 11 for stirring the toner 5 inside the developer container 8a. Magnetic toner in the form of a one-component magnetic developer is used as the toner 5 in the present embodiment.

The developing sleeve 3 is a non-magnetic developer carrier having a built-in fixed magnet 31. The developing sleeve 3 is rotatably provided in an opening, of the developer container 8a, that is provided at a position opposing the photoconductor 1 (FIG. 3). The developing sleeve 3 comprises, for instance, an aluminum pipe having a diameter of 14 mm, and rotates at a speed of 205 mm/s in the counterclockwise direction R2 of the arrow of FIG. 1. Four alternately disposed magnetic poles N, S, N, S of the fixed magnet 31, have each a magnetic flux density of 75 mT. The toner 5 inside the developer container 8a is carried, on the developing sleeve 3, by virtue of the magnetic forces of the magnetic poles N, S, N, S, and is transported in the R2 direction accompanying the rotation of the developing sleeve 3.

The elastic blade 4 is fixed to an opening of the developer container 8a in such a way so as to come in contact with the surface of the developing sleeve 3, and regulate the amount of toner 5 that is carried and transported by the developing sleeve 3. The elastic blade 4 regulates the thickness of the toner 5 on the developing sleeve 3, to form a developer layer (toner layer) of a predetermined thickness. The layer of toner 5 thus formed is transported, accompanying the rotation of the developing sleeve 3, to a developing section that is formed by the developing sleeve 3 and the photoconductor 1, to develop the electrostatic latent image that is formed on the photoconductor 1.

The stirring member 11 is provided so as to be rotatable about a rotary shaft 11a. The toner 5 inside the developer container 8a is loosened and caused to circulate throughout the interior of the developer container 8a by the rotating stirring member 11. A configuration is achieved as a result wherein degradation of the toner 5 is suppressed, and the toner 5 inside the developer container 8a can be consumed thoroughly.

The stirring member 11 is a flexible sheet-like member configured so as to deform on account of resistance from the toner 5 during rotation. Deformation of the stirring member 11 is detected by a piezoelectric element 12, as a detection member, that is attached to the stirring member 11. A reference-setting projection 9, as a deflection forming portion, is provided, inside the developer container 8a, at a region outside (above) a accumulation region of the toner 5, in such a manner that the reference-setting projection 9 can come in contact with the rotating stirring member 11. The term accumulation region of the toner 5 denotes herein a region at which most of the toner 5 accumulates in the interior (accommodating portion) of the developer container 8a in a static manner, without floating up or splashing, during normal use. The rotary shaft 11a of the stirring member 11 is preferably in a state of not being buried within the accumulation region of the toner 5, from the viewpoint of detection precision. However, the rotary shaft 11a, or the root side of the stirring member 11, which exhibits a relatively small deformation amount, may be in a state of being slightly buried within the accumulation region, so long as deformation of the leading end side of the stirring member 11, the deformation amount whereof is relatively large, is not affected thereby, i.e. so long as detection precision is little affected.

<Configuration of the Stirring Member and the Piezoelectric Element>

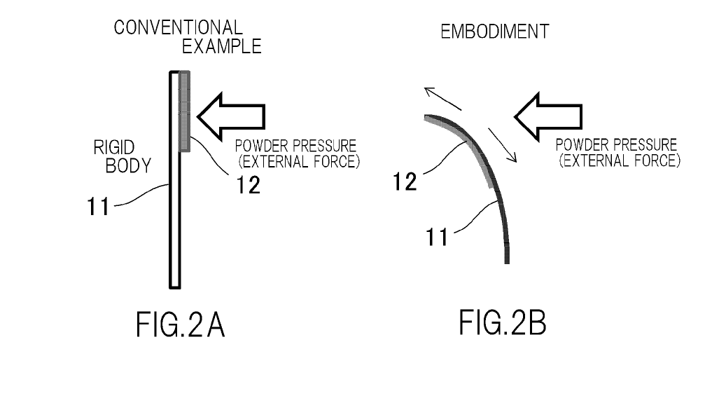

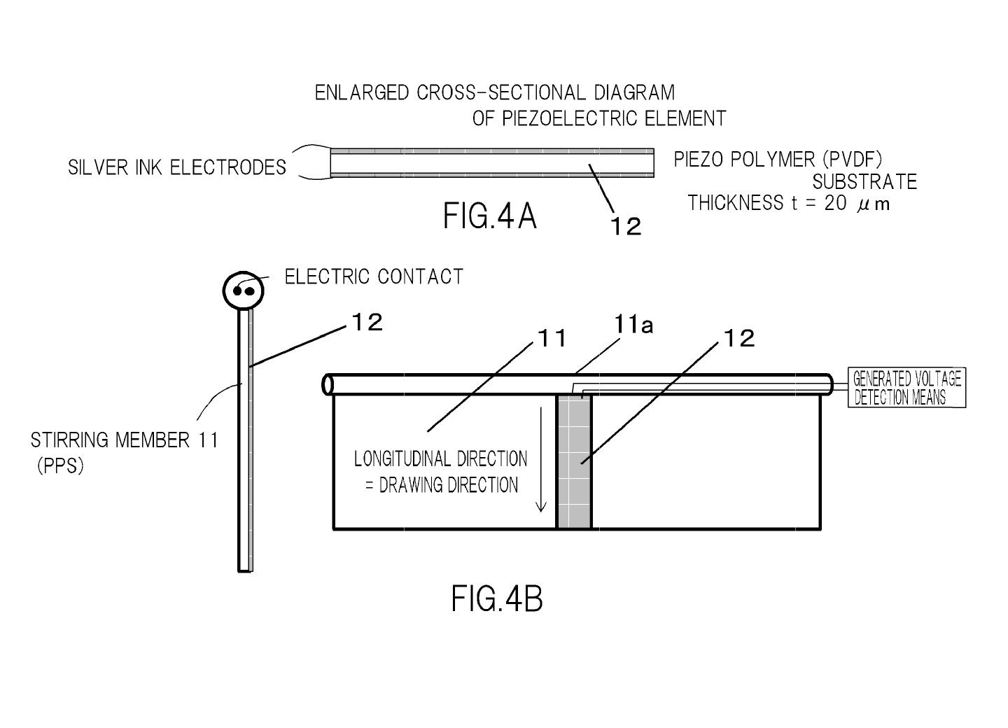

An explanation follows next with reference to FIGS. 2A, 2B, 4A and 4B, on the configuration of the stirring member and the piezoelectric element. FIGS. 2A, 2B are schematic cross-sectional diagrams illustrating the configuration of the stirring members, where FIG. 2A illustrates a conventional stirring member and FIG. 2B illustrates the stirring member of the present embodiment. FIGS. 4A, 4B are schematic diagrams illustrating the configuration of the stirring member of the present embodiment, where FIG. 4A is a schematic cross-sectional diagram of a piezoelectric element, and FIG. 4B is a cross-sectional diagram and a front-view diagram illustrating the configuration of the stirring member. In the present embodiment, as illustrated in FIGS. 4A, 4B, a sheet-like member, being a flexible member having an elastic restoring force, is used as the stirring member 11, such that the thin film-like piezoelectric element 12 is integrally bonded to the deflection surface of the stirring member 11, in such a manner so as to deflect in a rolling direction (i.e. a drawing direction, which is a direction in which the piezoelectric element is drawn to be shaped into a thin film by a rolling process) of high piezoelectricity. The piezoelectric element 12 is affixed to the stirring member 11, at a surface of the latter opposite that where the stirring member 11 comes in contact with the reference-setting projection 9 (upstream side of the stirring member 11 in the rotation direction thereof), in such a manner that the piezoelectric element 12 extends in a direction perpendicular to the rotary shaft 11a of the stirring member 11.

The stirring member 11 is a sheet-like member made up of a resin such as polyphenylene sulfide (PPS) or polyethylene terephthalate (PET). The stirring member 11 has a thickness of 150 μm, so as to be flexible while exhibiting a sufficient elastic restoring force towards bending stress.

A piezo film (by Tokyo Sensor Co., Ltd.), which is a polymer piezoelectric element, is used as the piezoelectric element 12 in the present embodiment. As illustrated in FIG. 4A, the material of the piezo film, which has a thickness of 20 μm, is polyvinylidene fluoride (PVDF). A respective silver ink electrode is formed on the front and rear faces of the piezoelectric element 12, which is bonded to the insulating stirring member 11 in such a manner that the rolling direction at the time of production, as the direction of highest piezoelectricity, is perpendicular to the stirring rotary shaft. The electrode surfaces of the piezoelectric element 12 are led out by way of metal films and metal wires, not shown, and are connected, by way of sliding electrodes, to a generated voltage detection circuit (peak detection circuit 13 and an effective value detection circuit 14) of the image forming apparatus main body.

In the present embodiment, as illustrated in FIG. 4B, a piezo film having a width of 10 mm, as the piezoelectric element 12, is bonded to the central section of the stirring member 11, in the axial direction thereof, in such a manner that the piezo film is integrated with the stirring member 11. The piezo film is imparted with an elongate shape in the direction perpendicular to the rotary shaft 11a of the stirring member 11. The length of the piezo film in this direction is set, as appropriate, within a range of 50 to 95 mm, in accordance with product specifications and so forth. In the configuration illustrated in FIGS. 4A, 4B, the end of the piezo film is in contact with the rotary shaft 11a of the stirring member 11, but a gap may be provided between the piezo film and the rotary shaft 11a. The position at which the piezo film is affixed in the longitudinal direction is not particularly limited, but preferably the piezo film is affixed to the stirring member 11 at the leading end side, where deformation is large. As a characterizing feature of the piezo film, the latter is flexible and can be made into a thin film. A small force in the rolling direction gives rise to large stress within the material of the piezo film, since the latter is thin and has a very small cross-sectional area. By virtue of that feature, the piezo film exhibits very high sensitivity towards elongation in the rolling direction, as compared with that in the thickness direction, with a standard effective sensitivity of rolling direction versus thickness direction of about 1000:1. Toner powder pressure (developer pressure) can thus be detected with high sensitivity by exploiting to the maximum such a characteristic of the piezo film. The sign of the output voltage of the piezo film varies depending on the rotation direction, the frontward deflection, and the deflection direction of the stirring member 11.

As described above, the sheet-like stirring member 11 is configured in such a manner that the leading end thereof is a free end that can undergo significant bending deformation. The piezoelectric element 12, in the form of the piezo film, is disposed in the stirring member 11 in such a manner that the piezoelectric element 12 deflects significantly in the rolling direction, in which the piezoelectricity of the piezo film is large. As a result, the flexural deformation of the stirring member 11 is converted to a large elongation deformation of the piezo film in the rolling direction, and hence very small changes in toner powder pressure can be detected through conversion, into large voltage changes, by the piezo film having a comparatively small area.

<Reference-Setting Projection>

The reference-setting projection 9 provided inside the developer container 8a will be explained next. The film-like piezoelectric element 12 has a temperature characteristic, and thus the voltage outputted by the piezoelectric element 12, on account of deflection of the stirring member 11, may in some instances vary significantly depending on differences in environmental temperature. The piezoelectric element 12 is film-like and is hence prone to exhibit large variability in mounting precision. This variability when the piezoelectric element 12 is bonded exerts in turn an influence on sensitivity, and the output voltage may vary significantly as a result. The purpose of the reference-setting projection 9 is to deliberately bring about a deflection state while the stirring member 11 is in a state of not being influenced by toner powder pressure, so as to detect the toner powder pressure, taking as a reference the output voltage value detected by piezoelectric element 12 at that time. The reference-setting projection 9 protrudes beyond the wall of the developer container 8a, so as to overlap with the movement region of the stirring member 11, outside the accumulation region of the toner 5 in the interior of the developer container 8a.

In the present embodiment, the reference-setting projection 9 is provided at the top of the interior of the developer container 8a, as illustrated in the figures. The reason for providing the reference-setting projection 9 at the top of the developer container 8a is to cause the piezoelectric element 12 to output a reference voltage value, by imparting deflection to the stirring member 11 and the piezoelectric element 12, while the latter are unaffected by the toner inside the container. Using this reference voltage value allows correcting the output voltage value of the piezoelectric element 12, even upon changes in the sensitivity thereof, derived from environmental fluctuations or the like, as described above.

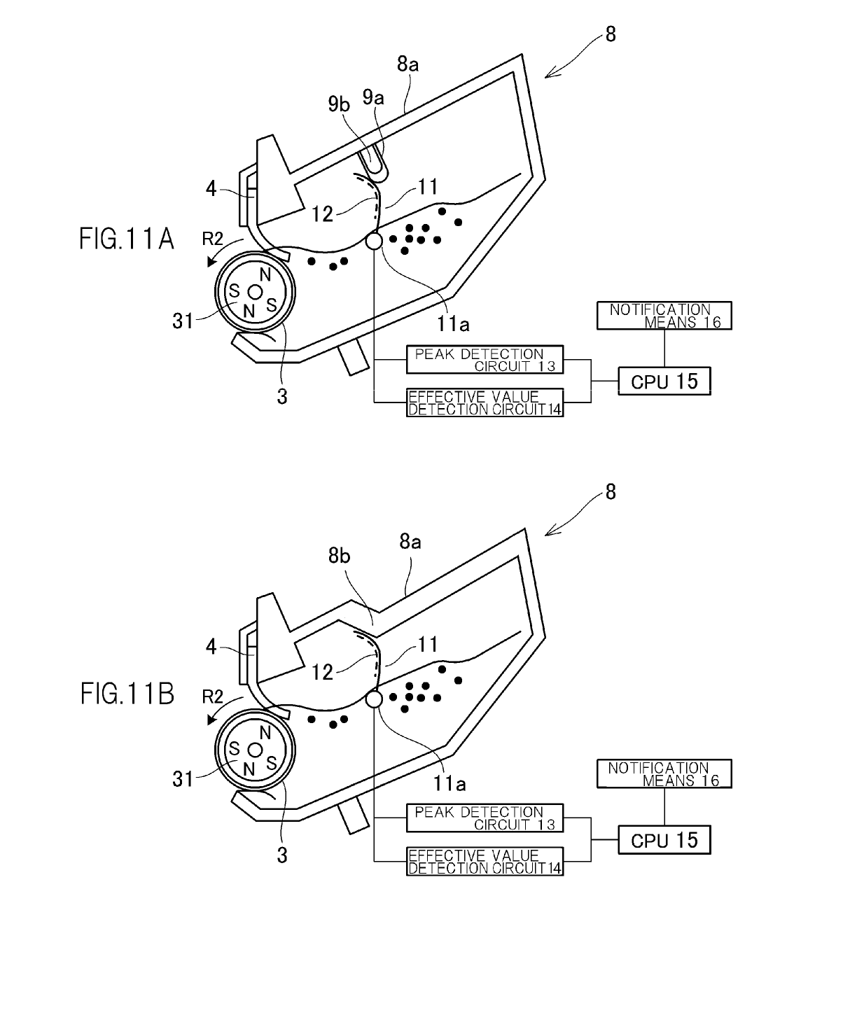

In the present Embodiment 1, the reference-setting projection 9 that protrudes down from the ceiling of the developer container 8a is provided for obtaining a reference voltage value, but the embodiment does not necessarily need to resort to a configuration where such a projection is provided. FIGS. 11A, 11B illustrate configurations of variations in which the configuration of the reference-setting projection 9 is modified. For instance, part of the ceiling of the developer container 8a may be lowered, to form a portion 8b that comes in contact with the stirring member 11, as illustrated in FIG. 11B. Various configurations can thus be adopted, so long as the reference-setting projection 9 can come in contact with the stirring member 11, and the latter can deflect while unaffected by the toner. The height and width of the reference-setting projection 9 (dimension in a direction perpendicular to the paper in FIG. 1) are set as appropriate in accordance with, for instance, the specifications of the stirring member 11 and the developer container 8a. The width of the reference-setting projection 9 may be identical to or different from the width of the stirring member 11. Further, a configuration may be resorted to wherein the reference-setting projection 9 is provided as a plurality thereof, in the abovementioned width direction. In this case, for instance, projections 9a, 9b of mutually different height may be arrayed as illustrated in FIG. 11A, in such a manner that the stirring member 11 having come in contact with the projections 9a, 9b is brought to specific deformation states. A configuration can be adopted herein, as appropriate, that allows eliciting a desired flexural deformation in the stirring member 11.

<Toner Residual Amount Detection Method>

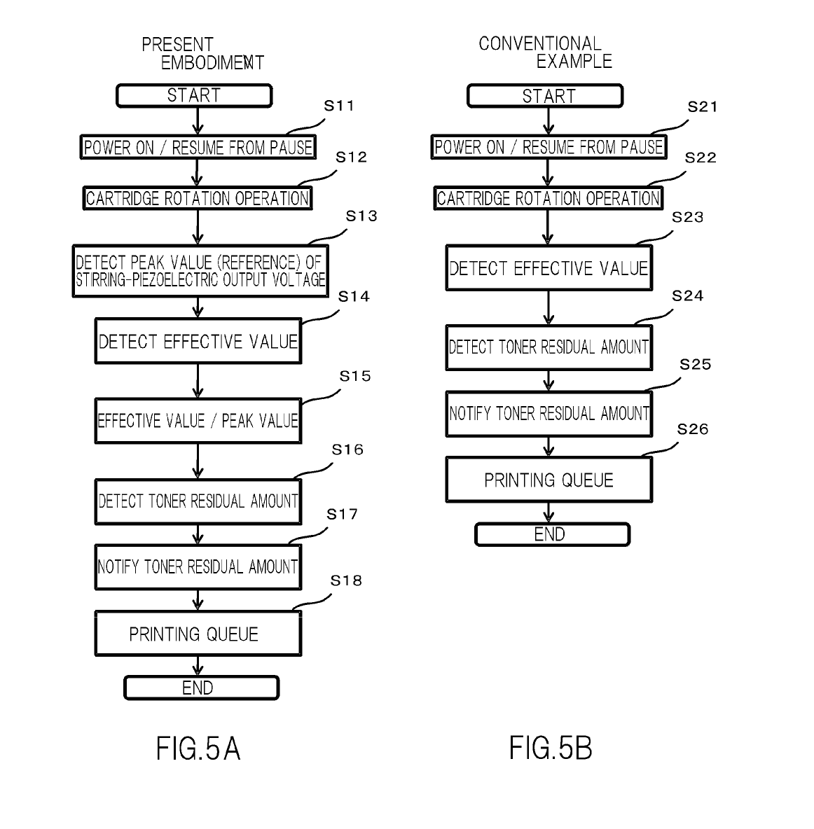

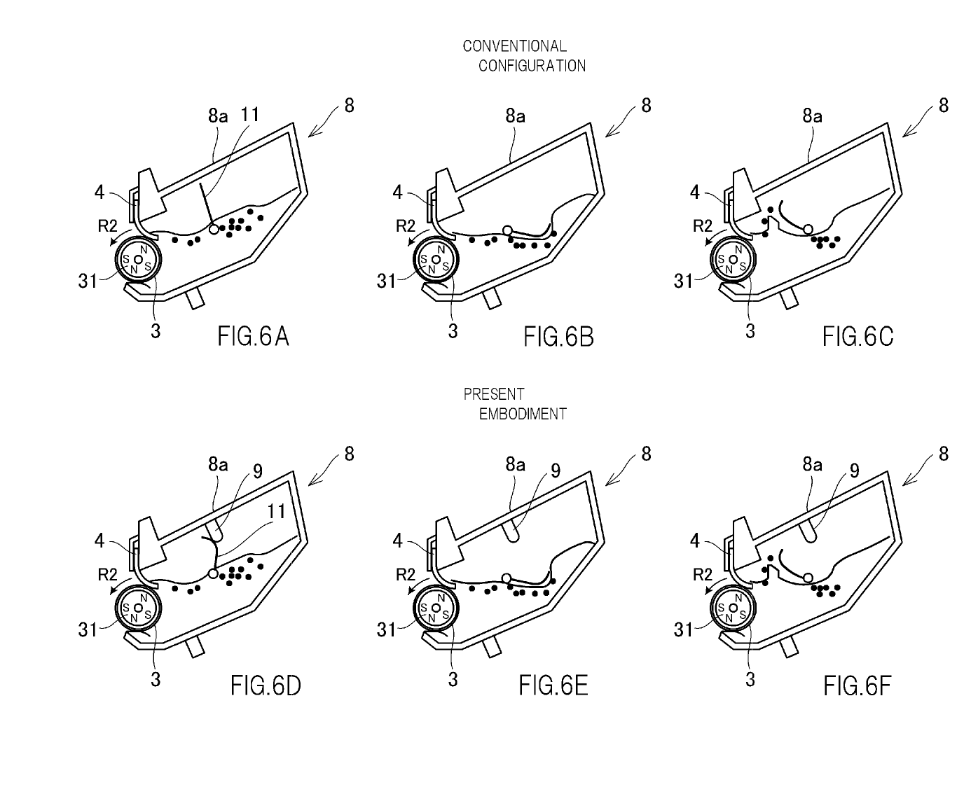

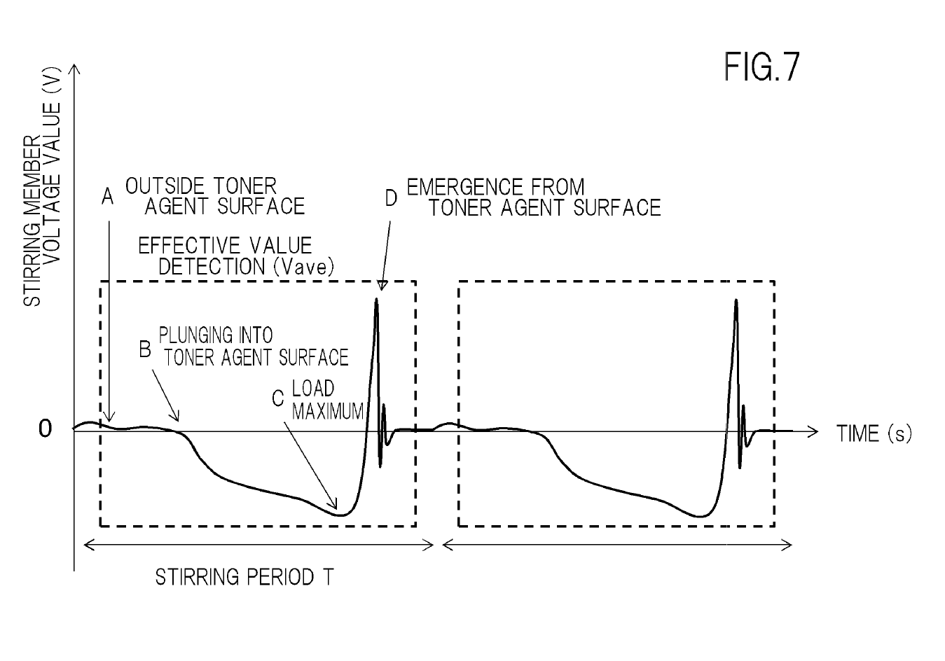

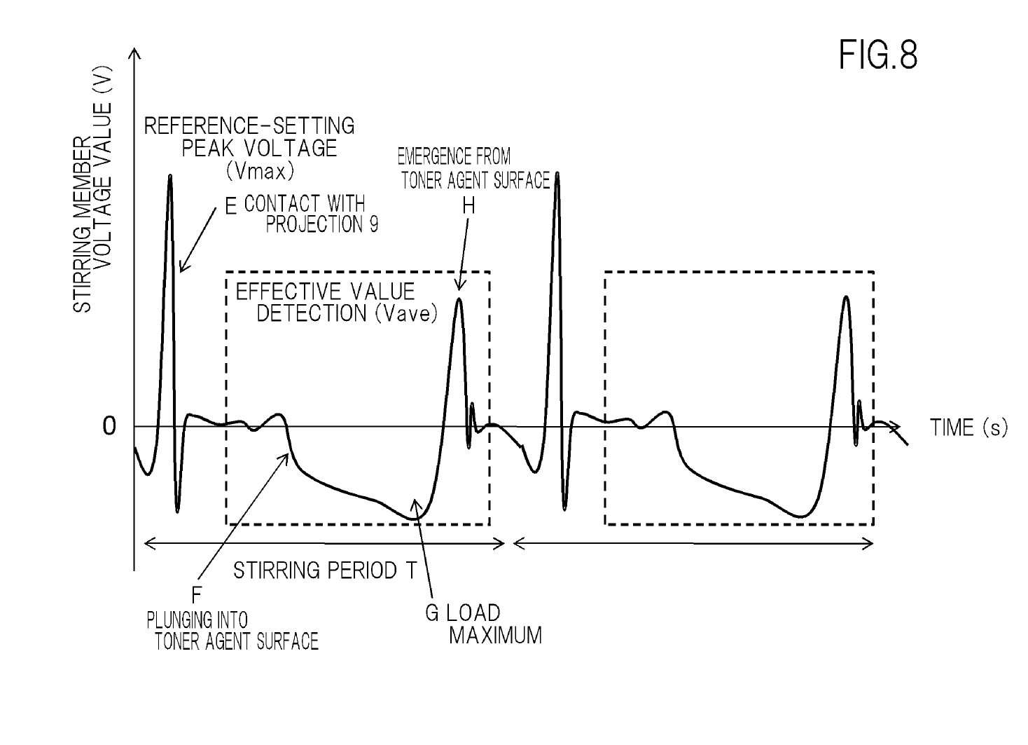

FIGS. 5A, 5B are flowcharts of toner residual amount detection, where FIG. 5A is a flowchart of the present embodiment, and FIG. 5B is a flowchart of a conventional example. FIGS. 6A to 6F are schematic cross-sectional diagrams of a developing apparatus, and illustrate the progress of a stirring-circulation process in a conventional example and in the present embodiment. FIG. 6A to FIG. 6C illustrate a stirring-circulation process in a conventional example, and FIG. 6D to FIG. 6F illustrate a stirring-circulation process in the present embodiment. FIG. 7 is a diagram illustrating a voltage waveform that is generated by the piezoelectric element upon rotation of the stirring member in a conventional example. FIG. 8 is a diagram illustrating a voltage waveform generated by the piezoelectric element upon rotation of the stirring member in the present embodiment.

### Conventional Example

As illustrated in FIG. 5B, toner residual amount detection is configured so as to be activated upon turning on of a main body power source, or upon returning from a main body paused state (S21). Upon turning on of the main body power source or upon return from a main body power source, a preparatory operation in which the stirring member 11 is rotated is executed prior to printing (S22). In the rotational operation of the stirring member there is detected the voltage generated by the piezoelectric element (piezo film) 12, to detect the toner residual amount.

As illustrated in FIG. 6A, the stirring member 11 starts rotating, clockwise in the figure, from a position outside the toner, and thereafter, the stirring member 11 plunges into the toner agent surface, as illustrated in FIG. 6B; thereby, the stirring member 11 undergoes flexural deformation such that the amount of deflection changes (increases) gradually. The amount of flexural deformation of the stirring member 11 increases in the counterclockwise direction (negative direction) in the figure, and the voltage generated in the piezoelectric element 12 changes in response thereto. The amount of deflection of the stirring member 11 increases little by little, and reaches eventually a maximum amount of deflection. Thereafter, the amount of deflection decreases gradually, and then deflection of the stirring member 11 is released sharply as the stirring member 11 emerges from the toner agent surface, as illustrated in FIG. 6C. The stirring member 11 deforms then sharply in the back-deflection direction (positive direction), and hence the piezoelectric element 12 outputs a voltage that exhibits a large change from negative to positive, as illustrated in FIG. 7, corresponding to the change in the deflection direction and deformation with an abrupt amount of deflection.

An effective value Vave of a serial output waveform generated in the stirring period is detected by an effective value detection circuit (S23). Thereafter, a CPU determines a toner residual amount on the basis of a relationship, prepared beforehand, between the toner residual amount and the output voltage of the piezoelectric element 12 (S24). The CPU notifies the residual amount to a user (S25), and brings the image forming apparatus to a printing queue state (S26).

### Present Embodiment

In the present embodiment a toner residual amount is detected by using a voltage peak value generated by the piezoelectric element 12 when the stirring member 11 contacts the reference-setting projection 9, and a voltage effective value that is generated by the piezoelectric element 12 while the stirring member 11 is immersed in the toner. In the present embodiment, a voltage detection means in the form of the peak detection circuit 13 and the effective value detection circuit 14 is connected to the piezoelectric element 12, such that a CPU 15, as a developer residual amount detection means, detects the toner residual amount on the basis of voltage values outputted by these circuits. The CPU 15 is also a control means for controlling the various operations of the image forming apparatus. The image forming apparatus is provided with a storage means in the form of a ROM, a RAM and the like, such that the CPU 15 performs various control processes by drawing on information stored in these memories and that is necessary for various computations.

The operating conditions in toner residual amount detection are identical to those in the above-described conventional configuration, as illustrated in FIG. 5A. Accordingly, toner residual amount detection is activated upon turning on of the main body power source, or upon return from a paused state (S11). Upon turning on of the main body power source or upon return from a main body power source, a preparatory operation of rotating the stirring member 11 is executed prior to printing (S12). Herein there is detected the voltage value generated during this rotational operation in the piezoelectric element 12, and equivalent to one rotation of the stirring member 11. To detect the toner residual amount, there are detected a voltage peak value Vmax generated by the piezoelectric element 12 upon contact of the stirring member 11 with the reference-setting projection 9, and the effective value Vave that is an average voltage value of the output voltage value generated by the piezoelectric element 12 while the stirring member 11 is immersed in the toner, over one rotation.

As illustrated in FIG. 6D, the stirring member 11 comes in contact with the reference-setting projection 9, from a position outside the toner, immediately after start of the rotation. The stirring member 11 is caused thereupon to sharply undergo significantly deflection, as a result of which the piezoelectric element 12 generates a large peak output voltage Vmax. The peak detection circuit 13 detects this voltage as the reference-setting peak voltage Vmax (S13). Thereafter, the stirring member 11 plunges into the toner agent surface, as illustrated in FIG. 6E, and undergoes flexural deformation. The amount of deflection of the stirring member 11 increases, along with the rotation, in the counterclockwise direction (negative direction) in the figure, and the voltage generated in the piezoelectric element 12 changes in response thereto. The amount of deflection of the stirring member 11 increases little by little, and reaches eventually a maximum amount of deflection. Thereafter, the amount of deflection decreases gradually, and then deflection of the stirring member 11 is released suddenly as the stirring member 11 emerges from the toner agent surface, as illustrated in FIG. 6F. The stirring member 11 deforms then sharply in the back-deflection direction (positive direction), and hence the piezoelectric element 12 outputs a voltage that exhibits a large change from negative to positive, as denoted by H in FIG. 8, corresponding to the change in the deflection direction and the sharp variation in the amount of deflection.

The effective value detection circuit 14 detects the effective value Vave within a range in the serial output waveform that are generated in one period T of stirring (see FIG. 8), while the stirring member 11 is immersed in the toner (while passing through the toner accumulation region), that does not include a region at which the peak voltage occurs (S14). Thereafter, the CPU 15 computes a value (Vave/Vmax) resulting from dividing the effective value by a reference-setting peak value (S15), and determines a toner residual amount on the basis of a relationship, prepared beforehand, between the toner residual amount and the output voltage of the piezoelectric element 12 (for instance, a table such as the one illustrated in FIG. 10) (S16). The CPU 15 notifies the toner residual amount to the user, by way of a notification means 16 (S17), and brings the image forming apparatus to a printing queue state (S18).

The reason for computing Vave/Vmax will be explained next. The temperature-voltage output characteristic of the film-like piezoelectric element 12 exhibits a substantially linear proportional relationship. Accordingly, a rise in temperature translates into a rise also of the effective value that is used in residual amount detection, which may preclude accurate residual amount detection. In some instances, moreover, the sensitivity may vary depending on the way in which the piezoelectric element 12 is mounted to the stirring member 11, such that the signal of residual amount detection exhibits variability for identical toner residual amounts. Accordingly, the outputted voltage values are normalized (Vave/Vmax) using a peak voltage value as a reference, to enable thereby residual amount detection excluding the influence of error derived from temperature changes and element mounting.

The timing of the residual amount detection in the present embodiment is designated as described above, but the detection timing is not particularly limited. The detection timing may be immediately before or immediately after the printing operation, but is preferably other than during printing. In the present embodiment, the toner residual amount is determined through sampling of output values at each period T of stirring, but any period may be relied upon for sampling, so long as the peak value derived from the reference-setting projection 9 can be compared with an effective value associated with the toner residual amount.

### Comparative Experiment Between a Conventional Example and the Present Embodiment

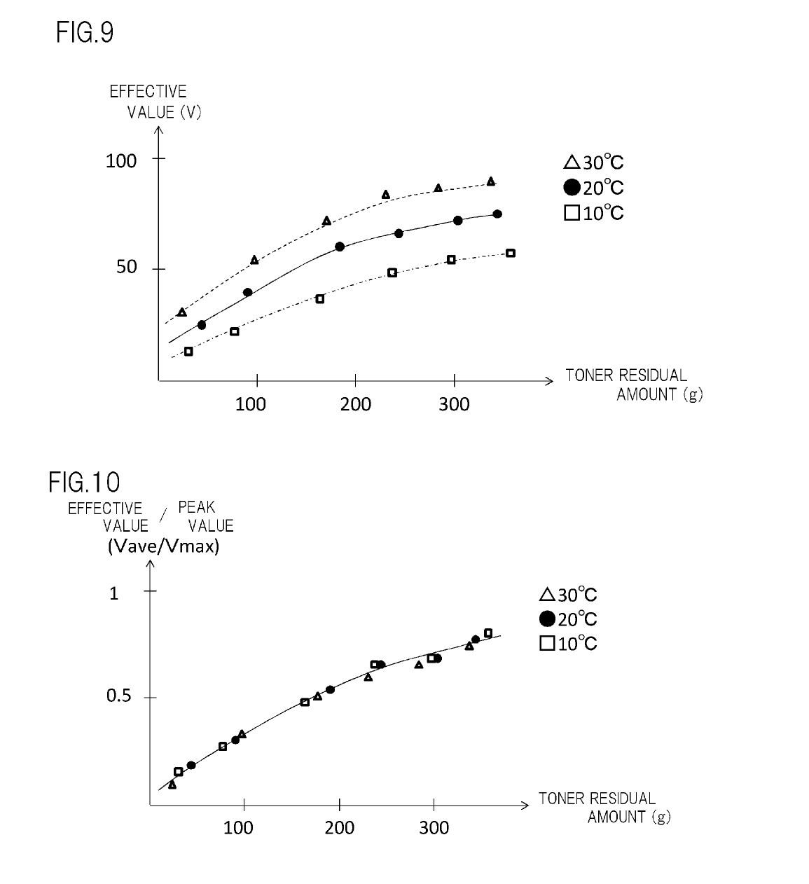

A durability experiment according to a conventional residual amount detection method and the residual amount detection method of the present embodiment was performed in order to compare the foregoing two methods. The durability test conditions included environment conditions of 10° C., 20° C. and 30° C., under which there was measured a profile of the toner residual amount as detected in accordance with the respective method. The experiment results are illustrated in FIG. 9 and FIG. 10. Herein, FIG. 9 is a diagram illustrating the profile of the toner residual amount as detected in accordance with a residual amount detection method of a conventional example, and FIG. 10 is a diagram illustrating the profile of the toner residual amount as detected in accordance with the residual amount detection method of Embodiment 1 of the present invention.

In a conventional method, as illustrated in FIG. 9, the output value of the piezoelectric element with respect to the toner residual amount exhibited different results depending on differences in environmental temperature. It is found that output values are higher when the environmental temperature is high, and that it is thus difficult to detect an accurate toner residual amount, due to differences in environmental temperature. In the present embodiment, by contrast, variability derived from environmental temperature is small, and computation results based on the toner residual amount and the output of the piezoelectric element evolve in the same way for any environment, as illustrated in FIG. 10. Accordingly, variability derived from environmental fluctuations and the like is small, and the toner residual amount can be detected with good precision.

### Embodiment 2

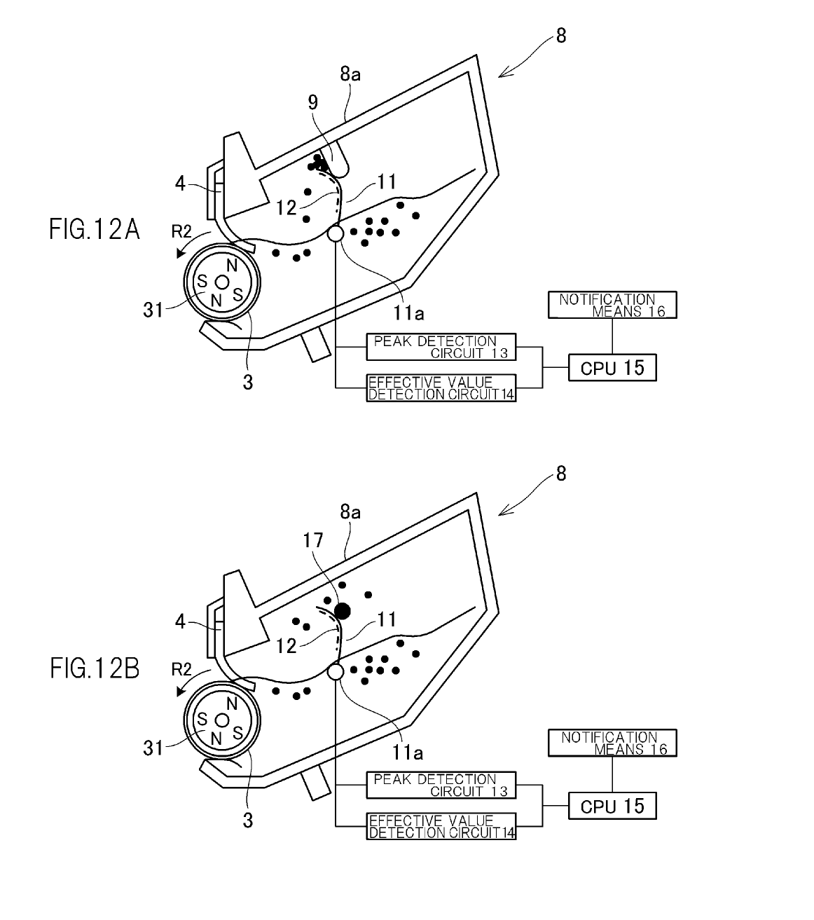

A developer container according to Embodiment 2 of the present invention will be explained next with reference to FIGS. 12A, 12B. Herein, FIGS. 12A, 12B are schematic cross-sectional diagrams illustrating the configuration of a developing apparatus according to the present embodiment, where FIG. 12A illustrates a schematic cross-sectional diagram of the developing apparatus of Embodiment 1, and FIG. 12B illustrates that of Embodiment 2. Only features different from those of Embodiment 1 will be explained herein. Features shared with Embodiment 1 will be denoted by the same reference symbols, and will not be explained again. Subject matter not explained herein is identical to that in Embodiment 1.

In a configuration where part of the wall of the developer container 8a, such as the reference-setting projection 9 of Embodiment 1, is caused to protrude, a toner jam may arise at the reference-setting position, as illustrated in FIG. 12A, due to scattering of toner when the stirring member 11 emerges from the toner agent surface. Such a toner jam may affect reference-setting detection.

As a characterizing feature of Embodiment 2, a reference shaft 17 that extends in the longitudinal direction of the developer container 8a (direction perpendicular to the paper in FIG. 12) is provided, as illustrated in FIG. 12B, instead of the reference-setting projection 9 of Embodiment 1. The reference shaft 17 is provided parallelly to the rotary shaft of the stirring member 11, at a position that overlaps the movement region of the stirring member 11, outside the accumulation region of the toner 5 within the developer container 8a. By virtue of such a configuration, a high-precision reference voltage can be detected, without toner jamming at the reference-setting position, even when toner scattering occurs when the stirring member 11 emerges from the toner agent surface.

The configuration for preventing splattered toner from remaining at the reference-setting position is not limited to providing the reference shaft 17, as in the present embodiment. For instance, an effect identical to that of the present embodiment may be accomplished by providing through-holes in the reference-setting projection 9 of Embodiment 1, such that splattering toner can pass through the holes.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-229714, filed on Nov. 5, 2013, which is hereby incorporated by reference herein in its entirety.

What is claimed is:

1. A developer container, comprising:
an accommodating portion in which a developer is accommodated;
a sheet-like stirring member that, by rotating, stirs the developer accommodated in the accommodating portion;
a piezoelectric element that is affixed to the stirring member and that outputs voltage when being deformed; and
a deflection forming portion that comes in contact with the stirring member, thereby causing the stirring member to deflect, when a free end of the stirring member is outside a developer accumulation region in the accommodating portion.

2. The developer container according to claim 1, wherein the piezoelectric element is affixed to a face, of the stirring member, on an opposite to a face that comes in contact with the deflection forming portion.

3. The developer container according to claim 1, wherein the piezoelectric element is affixed to the stirring member so as to extend in a direction that is perpendicular to a rotary shaft of the stirring member.

4. The developer container according to claim 1, wherein the piezoelectric element is affixed to the stirring member at least at a central section in the direction of a rotary shaft of the stirring member.

5. The developer container according to claim 1, wherein the piezoelectric element is formed in an elongate shape in a direction perpendicular to a rotary shaft of the stirring member.

6. The developer container according to claim 1, wherein the deflection forming portion is part of a wall of the accommodating portion.

7. The developer container according to claim 1, wherein the deflection forming portion is a projection that protrudes from a wall of the accommodating portion, so as to overlap a movement region of the stirring member, outside the accumulation region.

8. The developer container according to claim 1, wherein the deflection forming portion is a shaft that is provided parallelly to a rotary shaft of the stirring member, at a position overlapping a movement region of the stirring member, outside the accumulation region.

9. A developing apparatus, comprising:
the developer container according to claim 1; and
a developer carrier, provided in an opening of the developer container, and carrying a developer.

10. A process cartridge for performing an image forming process of forming an image, by way of a developer, on a recording medium, the process cartridge being configured so as to be detachably mounted to an apparatus main body of an image forming apparatus,
wherein the process cartridge comprises the developer container according to claim 1.

11. An image forming apparatus in which an image is formed by a developer on a recording medium,
the apparatus comprising:
the developer container according to claim 1;
voltage detection means for detecting voltage that is outputted by the piezoelectric element; and
developer residual amount detection means for detecting a residual amount of the developer that is accommodated in the accommodating portion, on the basis of a voltage value detected by the voltage detection means, wherein
the developer residual amount detection means
detects the residual amount of the developer on the basis of
a reference voltage value, which is an output voltage value of the piezoelectric element detected by the voltage detection means upon occurrence of flexural deformation due to contact of the stirring member with the deflection forming portion, and
an effective value of an output voltage value of the piezoelectric element detected by the voltage detection means while the stirring member is passing through the accumulation region, from among output voltage values of the piezoelectric element outputted over one rotation of the stirring member.

12. The developer container according to claim 1, wherein a residual amount of the developer is detected on the basis of a signal from the piezoelectric element.

13. The developer container according to claim 1, wherein the sheet-like stirring member is a flexible member.

14. The developer container according to claim 1, wherein the piezoelectric element is a film-like element.
